(19) United States
(12) Patent Application Publication
(10) Pub. No.: US 2026/0153589 A1
(43) Pub. Date: Jun. 4, 2026

(54) PANEL SELECTION FOR POSITIONING

(71) Applicant: Nokia Technologies Oy, Espoo (FI)

(72) Inventors: Ryan KEATING, Naperville, IL (US); Tao TAO, Shanghai (CN); Yong LIU, Shanghai (CN)

(21) Appl. No.: 18/703,935

(22) PCT Filed: Oct. 25, 2021
(86) PCT No.: PCT/CN2021/125997

§ 371 Date: Apr. 23, 2024

(51) Int. Cl. G01S 5/00

(52) U.S. Cl. CPC G01S 5/0072; G01S 5/0205; H04W 4/023; G01S 2205/01; H04B 7/06956

(57) ABSTRACT

A method, a device, an apparatus, and a non-transitory computer readable medium are provided. The method comprises: performing, at a first device, an exchange of panel information between the first device and a second device (310); determining, based on the exchange of the panel information, whether one or more receiving panels at the first device and at least one transmitting panel at the second device are available for a positioning (320); performing the positioning measurement of the first device based on the determined availability (330). By the panel information exchange and the panel selection mechanism for the positioning measurement proposed in the method, higher accuracy of positioning can be achieved.

### FIELD

Embodiments of the present disclosure generally relate to the field of telecommunication and in particular to devices, methods, apparatuses and computer readable storage media of panel selection for positioning.

### BACKGROUND

The native positioning has been supported in New Radio (NR). Some solutions are specified for NR positioning in Release 16. For example, the solutions may comprise Downlink Time Difference of Arrival (DL-TDOA), Uplink Time Difference of Arrival (UL-TDOA), Downlink Angle of Departure (DL-AoD), Uplink Angle of Arrival (UL-AoA), Enhanced Cell ID (E-CID), and Multi-cell Round Trip Time (Multi-RTT).

Currently, the NR positioning is to be developed for the supporting of the Industrial Internet of Things (IoT) use cases.

### SUMMARY

In general, example embodiments of the present disclosure provide a solution of panel selection for positioning.

In a first aspect, there is provided a method. The method comprises performing, at a first device, an exchange of panel information between the first device and a second device; determining, based on the exchange of the panel information, whether one or more receiving panels at the first device and at least one transmitting panel at the second device are available for a positioning measurement of the first device; and performing the positioning measurement of the first device based on the determined availability.

In a second aspect, there is provided a first device. The first device comprises at least one processor; and at least one memory including computer program codes; the at least one memory and the computer program codes are configured to, with the at least one processor, cause the first device at least to perform, at a first device, an exchange of panel information between the first device and a second device; determine, based on the exchange of the panel information, whether one or more receiving panels at the first device and at least one transmitting panel at the second device are available for a positioning measurement of the first device; and perform the positioning measurement of the first device based on the determined availability.

In a third aspect, there is provided an apparatus comprising means for performing, at a first device, an exchange of panel information between the first device and a second device; means for determining, based on the exchange of the panel information, whether one or more receiving panels at the first device and at least one transmitting panel at the second device are available for a positioning measurement of the first device; and means for performing the positioning measurement of the first device based on the determined availability.

In a fourth aspect, there is provided a computer readable medium having a computer program stored thereon which, when executed by at least one processor of a device, causes the device to carry out the method according to the first aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a signaling chart illustrating a process of panel selection for positioning according to some example embodiments of the present disclosure;

FIG. 3 shows a flowchart of an example method of panel selection for positioning according to some example embodiments of the present disclosure;

FIG. 4 shows a simplified block diagram of a device that is suitable for implementing example embodiments of the present disclosure; and

FIG. 5 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements. These elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

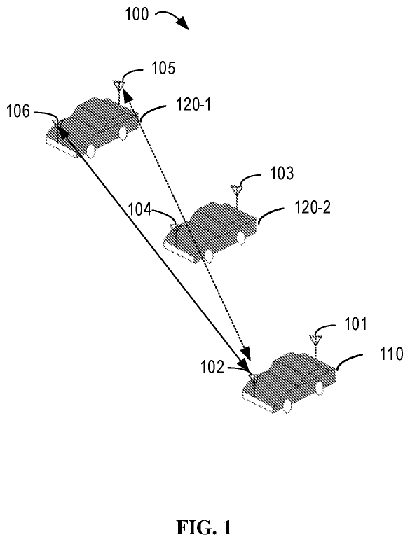

FIG. 1 shows an example communication network 100 in which embodiments of the present disclosure can be implemented. As shown in FIG. 1, the communication network 100 may comprise a terminal device 110 (hereinafter may also be referred to as a first device 110 or a target UE 110 and terminal devices 120-1 to 120-2 (hereinafter may also be referred to as a second device 120 or a supporting UE 120 collectively or a first supporting UE 120-1 and a second supporting UE 120-2 respectively). The terminal device 110 and the terminal devices 120-1 to 120-2 can communicate data and control information to each other. It is to be understood that the number of transmitting device and receiving device shown in FIG. 1 is given for the purpose of illustration without suggesting any limitations. The communication network 100 may include any suitable number of terminal devices.

The communication between the terminal device 110 and the terminal devices 120-1 and/or 120-2 can be referred to as the sidelink communication. The sidelink transmission between the terminal device 110 and the terminal devices 120-1 and/or 120-2 can be performed via a Physical Sidelink Control Channel (PSCCH) and a Physical Sidelink Shared Channel (PSSCH).

The communication network 100 can be implemented in a scenario of Vehicle-to-Everything (V2X) communication. In general, V2X communication can be divided into four types, including Vehicle-to-Vehicle (V2V), Vehicle-to-Pedestrian (V2P), Vehicle-to-Infrastructure (V2I), Vehicle-to-Network (V2N). Communication between terminal devices (that is, V2V, V2P, V2I communications) can be performed via sidelinks.

In release 16, the support for V2X was also added to NR in the form of sidelink communications. Enhancements on the sidelink have also been discussed in Release 17. As of yet positioning support has not been added to the sidelink and the positioning work has kept sidelink explicitly out of the scope of the work. However, many sidelink use cases have positioning requirements, especially for the IoT use cases.

5GAA has studied the different positioning technologies that may be used to meet the accuracy requirements in V2X applications. For example, as described above, the solutions may comprise DL-TDOA, UL-TDOA, DL-AOD, UL-AoA, E-CID, and Multi-cell Multi-RTT, etc. Sidelink positioning has been identified as important to meet high accuracy use cases, especially when GNSS coverage is not available. According to the study of the use cases and requirements of V2X and sidelink positioning in release 17, three main scenarios for V2X are proposed, namely in coverage, partial coverage, and out of coverage.

In general, the Line-of-Sight (LoS) conditions are optimal for achieving high positioning measurement accuracy. In V2X use cases with very strict requirements (e.g., 10 cm), it is critical to have LoS measurements used in the positioning calculation.

In the V2X scenario, the terminal device may have multiple panels (may also be referred to as distributed antenna systems) which can be placed in different locations on a vehicle. For example, the terminal device may have one antenna panel on both the front and back bumpers. As shown in FIG. 1, for example, the target UE 110 may have an antenna panel 102 arranged at the front bumper and a further antenna panel 101 arranged at the back bumper. In this way, a target UE may have different LoS/Non Line-of-Sight (NLoS) conditions to a supporting UE based on the particle pair of antenna panels selected. As shown in FIG. 1, the antenna panel 102 of the target UE 110 and an antenna panel 106 of the supporting UE 120-1 may be in LoS status and the antenna panel 102 of the target UE 110 and an antenna panel 105 of the supporting UE 120-1 may be in NLOS status, for example.

Therefore, to enhance the positioning of the target UE, it is to be expected that the target UE may select a best antenna panel pair from a positioning point of view.

The solution of the present disclosure proposes a mechanism of panel selection and V2X positioning. The target UE may perform an exchange of panel information between the target UE and the supporting UE. The target UE may determine, based on the exchange of the panel information, whether one or more receiving panels at the target UE and at least one transmitting panel at the supporting UE are available for a positioning measurement of the target UE and perform the positioning measurement of the target UE based on the determined availability.

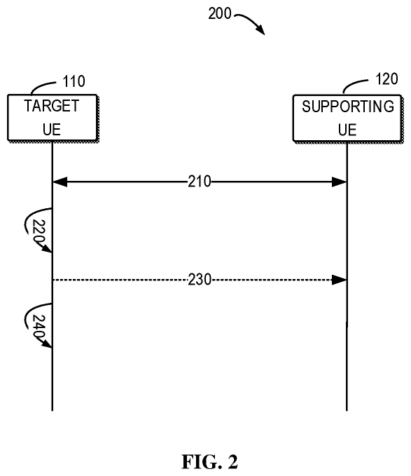

Principle and implementations of the present disclosure will be described in detail below with reference to FIG. 2, which shows a signaling chart illustrating a process 200 of panel selection for positioning according to some example embodiments of the present disclosure. For the purpose of discussion, the process 200 will be described with reference to FIG. 1. The process 200 may involve the target UE 110 and the supporting UE 120.

Now the reference is made to FIG. 2, after initiating a sidelink positioning procedure of the target UE 110, the target UE 110 may perform 210 an exchange of panel information with the supporting UE 120. The panel information to be exchanged between the target UE 110 and the supporting UE 120 may comprise the number of antenna panels arranged at the supporting UE 120 (hereafter may also be referred to as transmitting (TX) panels) and the number of antenna panels arranged at the target UE 110 (hereafter may also be referred to as receiving (RX) panels).

Furthermore, the panel information to be exchanged may also comprise distances between two panels. For example, the distances of respective pairs of the RX panels and the TX panels, the distances between two TX panels.

Moreover, the panel information to be exchanged may also comprise locations of the TX panels and the RX panels.

After exchanging the panel information, the target UE 110 may determine the availability of one or more Rx panels at the target UE 110 and at least one Tx panel at the supporting UE 120 for the positioning measurement of the target UE 110. In this way, the target UE 110 may select one or more suitable pairs of a Rx panel and a Tx panel for the positioning measurement of the target UE 110.

In some example embodiments, the target UE 110 may determine 220 the availability of one or more Rx panels at the target UE 110 and at least one Tx panel at the supporting UE 120 based on the observability between respective pairs of one or more Rx panels at the target UE 110 and at least one Tx panel at the supporting UE 120.

For example, if a pair of a Rx panel and a TX panel are in LOS status, the pair of the Rx panel and the TX panel can be considered as available for the positioning measurement of the target UE 110.

In some example embodiments, the target UE 110 may determine the observability between respective pairs of one or more Rx panels at the target UE 110 and at least one Tx panel at the supporting UE 120 by using any HD mapping data.

In some example embodiments, the target UE 110 may also determine the LoS/NLOS situation between respective pairs of one or more Rx panels at the target UE 110 and at least one Tx panel at the supporting UE 120 based on other possible LoS detection algorithms, such as Machine-Learning (ML) based techniques or Channel Impluse Response (CIR) based techniques.

In some example embodiments, the availability of one or more Rx panels at the target UE 110 and at least one Tx panel at the supporting UE 120 may be determined by the target UE 110 based on received signal from the supporting UE 120. For example, the signal can be received by the transmission of Sidelink Control Information (SCI). Alternatively, the received signal may also be a sidelink Synchronizing signal. The target UE 110 may further determine the availability of one or more Rx panels and at least one Tx panel for the positioning measurement of the target UE 110 based on AoA associated with the received signal and the exchanged panel information, such as the locations of the Tx panels and the Rx panels.

In some example embodiments, if the target UE 110 determines that a Rx panel at the target UE 110 and a plurality of Tx panels at the supporting UE 120 are available for the positioning measurement of the target UE 110, the target UE 110 may determine respective ToAs at the Rx panel based on positioning signals transmitted from the plurality of Tx panels and determine 240 position of the target UE 110 at least based on the respective time of arrivals.

For example, the target UE 110 may average the respective ToAs to obtain a final ToA and estimate the position of the target UE 110 based on the final ToA.

In this case, if the target UE 110 determines a Rx panel at the target UE 110 and a plurality of Tx panels at the supporting UE 120 are available for the positioning measurement, the target UE 110 may turn off the Rx panels at the target UE 110 other than the available Rx panel.

In some example embodiments, if the target UE 110 determines that a plurality of Rx panels at the target UE 110 and at least one Tx panel at the supporting UE 120 are available for the positioning measurement of the target UE 110, the target UE 110 may determine respective ToAs at the plurality of Rx panels based on positioning signals transmitted from the at least one Tx panel and determine 240 position of the target UE 110 at least based on the respective time of arrivals.

Similarly, the target UE 110 may average the respective ToAs to obtain a final ToA and estimate the position of the target UE 110 based on the final ToA.

In some example embodiments, if the target UE 110 determines that at least one Rx panel at the target UE 110 and a set of Tx panels at the supporting UE 120 are available for the positioning measurement of the target UE 110, the target UE 110 may transmit 230 a request of transmitting positioning signals from the set of the Tx panels to the supporting UE 120. After receiving the positioning signals from the set of the Tx panels, the target UE 110 may perform the positioning measurement based on positioning signals transmitted from the set of Tx panels.

In this case, the supporting UE 120 may also transmit from all panels in orthogonal way (e.g., TDM) and then the target UE 110 may use AoA to determine LoS/NLOS and then measure the timing.

In some example embodiments, if the target UE 110 determines that no Tx panel at the supporting UE 120 is available for the positioning measurement, the target UE 110 may discard the supporting UE 120 for the positioning measurement and select a further supporting UE.

By the panel information exchange and the panel selection mechanism for the positioning measurement proposed in the present disclosure, higher accuracy of positioning can be achieved.

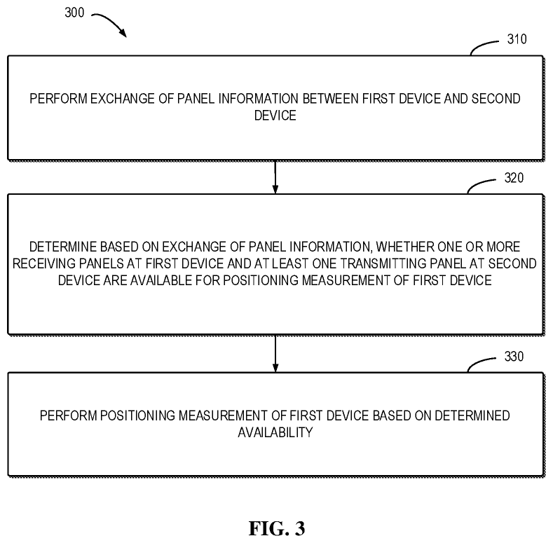

FIG. 3 shows a flowchart of an example method 300 of panel selection for positioning according to some example embodiments of the present disclosure. The method 300 can be implemented at the first device 110 as shown in FIG. 1. For the purpose of discussion, the method 300 will be described with reference to FIG. 1.

At 310, the first device performs an exchange of panel information between the first device and a second device.

In some example embodiments, the panel information comprises at least one of the number of receiving panels arranged at the first device, the number of transmitting panels arranged at the second device, respective distances between the receiving panels and the transmitting panels, respective distances between the transmitting panels; or respective locations of the receiving panels and the transmitting panels.

At 320, the first device determines, based on the exchange of the panel information, whether one or more receiving panels at the first device and at least one transmitting panel at the second device are available for a positioning measurement of the first device.

In some example embodiments, if the first device determines that respective pairs of the one or more receiving panels and the at least one transmitting panel are in a line-of-sight status, the first device may determine the one or more receiving panels and the at least one transmitting panel are available for the positioning measurement of the first device.

In some example embodiments, the first device may obtain mapping data related an environment of the first device; and determine the availability at least based on the mapping data and the panel information.

In some example embodiments, the first device may determine respective angle of arrivals associated with the at least one transmitting panel based on the received signal; and determine the availability based on the panel information and the respective angle of arrivals.

At 330, the first device performs the positioning measurement of the first device based on the determined availability.

In some example embodiments, if the first device determines that a first receiving panel at the first device and more than one transmitting panels at the second devices are available for the positioning measurement of the first device, the first device may determine respective time of arrivals at the first receiving panel based on positioning signals transmitted from the more than one transmitting panels and determine a position of the first device at least based on the respective time of arrivals.

In some example embodiments, the first device may turn off receiving panels arranged at the first device other than the first receiving panel.

In some example embodiments, if the first device determines that a plurality of receiving panels at the first devices and at least one transmitting panels at the second devices are available for the positioning measurement of the first device, the first device may determine respective time of arrivals at the plurality of receiving panels based on respective positioning signals transmitted from the at least one transmitting panels and determine a position of the first device at least based on the respective time of arrivals.

In some example embodiments, if the first device determines that at least one receiving panel at the first devices and a set of transmitting panels at the second device are available for the positioning measurement of the first device, the first device may transmit, to the second device, a request of transmitting positioning signals from the set of the transmitting panels and perform the positioning measurement based on positioning signals transmitted from the set of transmitting panels.

In some example embodiments, if the first device determines that no transmitting panel at the second device is available for the positioning measurement of the first device, the first device may determine a third device for the positioning measurement of the first device.

In some example embodiments, the first device comprises a sidelink terminal device and the second device comprises a sidelink terminal device.

In some example embodiments, an apparatus capable of performing the method 300 (for example, implemented at the UE 110) may comprise means for performing the respective steps of the method 300. The means may be implemented in any suitable form. For example, the means may be implemented in a circuitry or software module.

In some example embodiments, the apparatus comprises means for performing, at a first device, an exchange of panel information between the first device and a second device; means for determining, based on the exchange of the panel information, whether one or more receiving panels at the first device and at least one transmitting panel at the second device are available for a positioning measurement of the first device; and means for performing the positioning measurement of the first device based on the determined availability.

FIG. 4 is a simplified block diagram of a device 400 that is suitable for implementing embodiments of the present disclosure. The device 400 may be provided to implement the communication device, for example the target UE 110 as shown in FIG. 1. As shown, the device 400 includes one or more processors 410, one or more memories 440 coupled to the processor 410, and communication modules 440 coupled to the processor 410.

The communication module 440 is for bidirectional communications. The communication module 440 has one or more communication interfaces to facilitate communication with one or more other modules or devices. The communication interfaces may represent any interface that is necessary for communication with other network elements. In some example embodiments, the communication module 440 may include at least one antenna.

The processor 410 may be of any type suitable to the local technical network and may include one or more of the following: general purpose computers, special purpose computers, microprocessors, digital reference signal processors (DSPs) and processors based on multicore processor architecture, as non-limiting examples. The device 400 may have multiple processors, such as an application specific integrated circuit chip that is slaved in time to a clock which synchronizes the main processor.

The memory 420 may include one or more non-volatile memories and one or more volatile memories. Examples of the non-volatile memories include, but are not limited to, a Read Only Memory (ROM) 424, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 422 and other volatile memories that will not last in the power-down duration.

A computer program 430 includes computer executable instructions that are executed by the associated processor 410. The program 430 may be stored in the ROM 420. The processor 410 may perform any suitable actions and processing by loading the program 430 into the RAM 420.

The embodiments of the present disclosure may be implemented by means of the program 430 so that the device 400 may perform any process of the disclosure as discussed with reference to FIGS. 2 to 3. The embodiments of the present disclosure may also be implemented by hardware or by a combination of software and hardware.

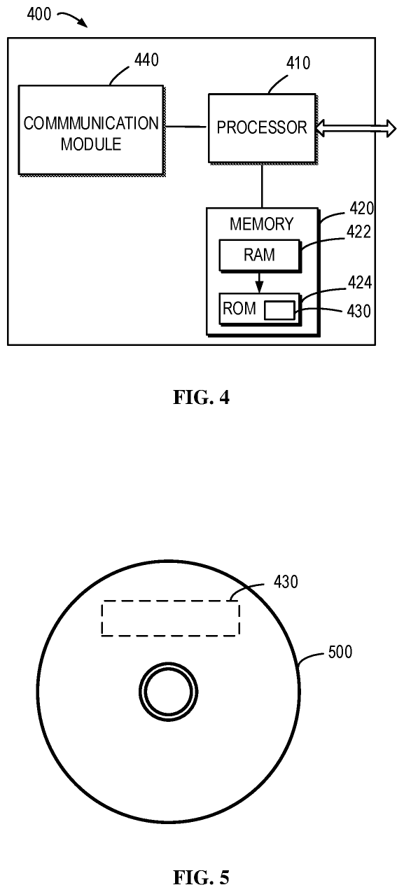

In some embodiments, the program 430 may be tangibly contained in a computer readable medium which may be included in the device 400 (such as in the memory 420) or other storage devices that are accessible by the device 400. The device 400 may load the program 430 from the computer readable medium to the RAM 422 for execution. The computer readable medium may include any types of tangible non-volatile storage, such as ROM, EPROM, a flash memory, a hard disk, CD, DVD, and the like. FIG. 5 shows an example of the computer readable medium 500 in form of CD or DVD. The computer readable medium has the program 430 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 300 as described above with reference to FIG. 3. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a reference signal, computer readable medium, and the like.

The computer readable medium may be a computer readable reference signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-24. (canceled)

25. A method comprising:
performing, at an apparatus, an exchange of panel information between the apparatus and a second apparatus;
determining, based on the exchange of the panel information, whether one or more receiving panels at the apparatus and at least one transmitting panel at the second apparatus are available for a positioning measurement of the apparatus; and
performing the positioning measurement of the apparatus based on the determined availability.

26. The method of claim 25, wherein the panel information comprises at least one of the following:
the number of receiving panels arranged at the apparatus,
the number of transmitting panels arranged at the second apparatus,
a distance between respective pairs of receiving panels and transmitting panels,
respective distances between the transmitting panels; or
respective locations of the receiving panels and the transmitting panels.

27. The method of claim 25, wherein determining the availability further comprises:
obtaining mapping data related to an environment of the apparatus; and
determining the availability at least based on the mapping data and the panel information.

28. The method of claim 25, wherein determining the availability further comprises:
determining respective angle of arrivals associated with the at least one transmitting panel; and
determining the availability based on the panel information and the respective angle of arrivals.

29. The method of claim 25, wherein performing the positioning measurement comprises:
determining respective time of arrivals at the first receiving panel based on positioning signals transmitted from the more than one transmitting panels, in accordance with a determination that a first receiving panel at the apparatus and more than one transmitting panels at the second apparatus are available for the positioning measurement of the apparatus; and
determining a position of the apparatus at least based on the respective time of arrivals.

30. The method of claim 25, wherein performing the positioning measurement further comprises:
determining respective time of arrivals at the plurality of receiving panels based on respective positioning signals transmitted from the at least one transmitting panels, in accordance with a determination that a plurality of receiving panels at the apparatus and at least one transmitting panels at the second apparatus are available for the positioning measurement of the apparatus; and
determining a position of the apparatus at least based on the respective time of arrivals.

31. The method of claim 25, wherein performing the positioning measurement further comprises:
transmitting, to the second apparatus, a request of transmitting positioning signals from the set of the transmitting panels, in accordance with a determination that at least one receiving panel at the apparatus and a set of transmitting panels at the second apparatus are available for the positioning measurement of the apparatus; and
performing the positioning measurement based on positioning signals transmitted from the set of transmitting panels.

32. The method of claim 25, wherein the apparatus comprises a sidelink terminal device and the second apparatus comprises a sidelink terminal device.

33. An apparatus comprising:
at least one processor; and
at least one memory storing instructions that, when executed with the at least one processor, cause the apparatus at least to:
perform, at the apparatus, an exchange of panel information between the apparatus and a second apparatus;
determine, based on the exchange of the panel information, whether one or more receiving panels at the apparatus and at least one transmitting panel at the second apparatus are available for a positioning measurement of the apparatus; and
perform the positioning measurement of the apparatus based on the determined availability.

34. The apparatus of claim 33, wherein the panel information comprises at least one of the following:
the number of receiving panels arranged at the apparatus,
the number of transmitting panels arranged at the second apparatus,
a distance between respective pairs of receiving panels and transmitting panels,
respective distances between the transmitting panels; or
respective locations of the receiving panels and the transmitting panels.

35. The apparatus of claim 33, wherein the apparatus is configured to determine the availability by:
determining that the one or more receiving panels and the at least one transmitting panel are available for the positioning measurement of the apparatus, in accordance with a determination that respective pairs of the one or more receiving panels and the at least one transmitting panel are in a line-of-sight status.

36. The apparatus of claim 33, wherein the apparatus is further configured to determine the availability by:
obtaining mapping data related to an environment of the apparatus; and
determining the availability at least based on the mapping data and the panel information.

37. The apparatus of claim 33, wherein the apparatus is further configured to determine the availability by:
receiving a signal from at least one transmitting panel arranged at the second apparatus;
determining respective angle of arrivals associated with the at least one transmitting panel based on the received signal; and
determining the availability based on the panel information and the respective angle of arrivals.

38. The apparatus of claim 33, wherein the apparatus is configured to perform the positioning measurement by:
determining respective time of arrivals at the first receiving panel based on positioning signals transmitted from the more than one transmitting panels, in accordance with a determination that a first receiving panel at the apparatus and more than one transmitting panels at the second apparatus are available for the positioning measurement of the apparatus; and
determining a position of the apparatus at least based on the respective time of arrivals.

39. The apparatus of claim 38, wherein the apparatus is further configured to:
turn off receiving panels arranged at the apparatus other than the first receiving panel.

40. The apparatus of claim 33, wherein the apparatus is further configured to perform the positioning measurement by:
determining respective time of arrivals at the plurality of receiving panels based on respective positioning signals transmitted from the at least one transmitting panels, in accordance with a determination that a plurality of receiving panels at the apparatus and at least one transmitting panels at the second apparatus are available for the positioning measurement of the apparatus; and
determining a position of the apparatus at least based on the respective time of arrivals.

41. The apparatus of claim 33, wherein the apparatus is further configured to perform the positioning measurement by:
transmitting, to the second apparatus, a request of transmitting positioning signals from the set of the transmitting panels, in accordance with a determination that at least one receiving panel at the apparatus and a set of transmitting panels at the second apparatus are available for the positioning measurement of the apparatus; and
performing the positioning measurement based on positioning signals transmitted from the set of transmitting panels.

42. The apparatus of claim 33, wherein the apparatus is further configured to perform the positioning measurement by:
determining a third apparatus for the positioning measurement of the apparatus, in accordance with a determination that no transmitting panel at the second apparatus is available for the positioning measurement of the apparatus.

43. The apparatus of claim 33, wherein the apparatus comprises a sidelink terminal device and the second apparatus comprises a sidelink terminal device.

44. A non-transitory computer readable medium comprising program instructions that, when executed with an apparatus, cause the apparatus to perform at least the following:.
performing, at the apparatus, an exchange of panel information between the apparatus and a second apparatus;
determining, based on the exchange of the panel information, whether one or more receiving panels at the apparatus and at least one transmitting panel at the second apparatus are available for a positioning measurement of the apparatus; and
performing the positioning measurement of the apparatus based on the determined availability.
